(19) United States
(12) Patent Application Publication
(10) Pub. No.: US 2009/0195435 A1
(43) Pub. Date: Aug. 6, 2009

(54) HAND-HELD DEVICE AND METHOD FOR DETECTING CONCEALED WEAPONS AND HIDDEN OBJECTS

(75) Inventors: Boris Kapilevich, Rishon LeZion (IL); Moshe Einat, Ariel (IL)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(73) Assignee: Ariel-University Research and Develoment Company Ltd., Ariel (IL)

(21) Appl. No.: 12/304,892

(22) PCT Filed: Jun. 18, 2007
(86) PCT No.: PCT/IL07/00736

§ 371 Date: Dec. 22, 2008

(30) Foreign Application Priority Data
Jun. 19, 2006 (IL) 176411

(51) Int. Cl. G01S 7/41; G01S 13/00

(52) U.S. Cl. 342/22; 342/202

(57) ABSTRACT

The present invention is an inexpensive, hand-held, and easy to operate millimeter-wave detection device that employs a non-imaging sensor which radiates a pulse of millimeter waves of a certain amplitude and frequency towards a target located at a distance from the detection device. The sensor receives pulses of millimeter waves that are reflected from the target and generates a voltage waveform that is characteristic mainly of the target material, while other parameters such as distance to the target are known. The processor of the detection device measures both the peak voltage and the rate of increase of the voltage until it reaches the maximum. Using an algorithm stored in a software module, the deviation between the rate of the voltage rise and the peak voltage is compared with values of similar parameters for a number of test targets made of different materials that were previously collected and stored in a calibration table in the memory of the device. A concealed object, e.g. a weapon, is positively identified when the measured voltage rise is found to be similar to one of the stored voltage rises. The circuitry of the detection device generates a visual and/or audio output to a display device which is indicative to the operator as to whether a concealed object is present and, if a match is found with the data in the calibration table, the nature of the concealed object is also displayed. In addition to the basic mode of operation described, various other operation modes can be employed with the detection device of the invention.

### FIELD OF THE INVENTION

The present invention relates to the field of detectors. More particularly, the invention relates to a device for detecting concealed weapons and various hidden objects by using a millimeter wavelength generator and detector.

### BACKGROUND OF THE INVENTION

The most prevalent device for detecting concealed weapons and metallic hidden objects is the magnetic metal detector. A stationary passage device, through which a person being examined walks, employs a metal detector and is deployed at portals such as airports, embassies, and other high risk checkpoints. A simple hand-held device is used at lower risk checkpoints, such as a mall entrance. While the passage device is precluded for use at lower risk checkpoints due to its cost and complexity, the use of the hand-held detection device necessitates a user to come in bodily contact with the person being examined, thereby exposing the user to a potentially hazardous and unanticipated situation, such as when the person being examined is found to be a suicide bomber.

Many devices are adapted to detect different kinds of concealed weapons, contraband and hidden objects by utilizing the fundamental properties of X-rays, optical, infrared (IR) and electromagnetic wave spectra, as well as acoustic phenomena. However, these systems have some significant limitations:
A detection device based on electromagnetic waves cannot detect plastic or ceramic weapons, chemical explosives, or narcotics;
A detection device based on X-ray and acoustic waves is efficacious only if it is deployed in relatively close proximity to an object of investigation;
A detection device based on optical and IR systems cannot identify concealed objects, such as those that are screened by clothes, fabric, paper, cardboard, and some building materials.

Many of the above drawbacks can be overcome by a detection device operating in the millimeter-wave range of radiation, i.e. having an electromagnetic wavelength between one millimeter and one centimeter corresponding to a bandwidth of 30-300 GHz, since its radiation can penetrate a majority of screening materials as well as fog, smoke, and dust at relatively long distances of up to several hundreds meters. A millimeter-wave detection device is therefore suitable for both indoor and outdoor applications.

The attenuation and reflection characteristics of ceramic, metallic and plastic weapons, as well as contraband such as narcotics, are different with respect to millimeter-wave radiation from those of skin, so that concealed objects may be detected by a suitable device.

Many millimeter-wave detection devices are known in the prior art, for example U.S. Pat. No. 4,910,523 U.S. Pat. No. 4,901,084, U.S. Pat. No. 4,940,986, U.S. Pat. No. 5,047,783, U.S. Pat. No. 5,073,782, U.S. Pat. No. 5,170,169, U.S. Pat. No. 5,202,692, U.S. Pat. No. 5,227,800, U.S. Pat. No. 5,760,397, U.S. Pat. No. 6,777,684, and U.S. Pat. No. 6,937,182. In these detection devices, an image of a concealed object is generated, generally by means of a millimeter wave imaging sensor and an array of imaging elements including antennas which detect millimeter-wave energy reflected from or emitted by objects in the field of view of the sensor, and an output signal responsive to millimeter wave energy detected by the antennas. Although these detection devices may provide high quality imaging, they are costly, particularly due to the need of an expensive scanner and positioning system, or of a large number of receivers defining a focal plane array when functioning as independent pixels. The time needed for image reconstruction with these prior art detection devices is excessively long at regions of high congestion of bystanders or pedestrians.

Due to the recent rise in global security problems and terror, security personnel urgently need an inexpensive, hand-held and easy to operate detection device that can be used in regions of high congestion of bystanders or pedestrians such as at the entrance of a train station, school, shopping mall, sports stadium or cinema, or on board a bus whereat a stationary passage device is not practical.

U.S. Pat. No. 6,359,582 discloses a hand-held concealed weapon detection system which comprises a transmitter for producing an output of frequencies in the microwave region, an antenna whose output is directed towards locations from which backscattered signals from weapons can potentially be received, a receiver for receiving the backscattered signals and operating over a range of self-resonant frequencies, and a signal processor for detecting the presence of a plurality of the self-resonant frequencies in the backscattered signals.

This detection device suffers from several deficiencies. Firstly, the wavelength of the transmitted radiation is in the relatively long microwave region, and therefore the entire suspect or target is irradiated. Consequently, specific locations of a suspect such as the arms or legs cannot be accurately detected due to the lack of spatial resolution. Secondly, a time-domain signature of a target is obtained by irradiating the target with a plurality of pulses such that each subsequent pulse has a greater frequency, and the target therefore absorbs a total accumulated energy level much greater than a detection device that irradiates with a single pulse. Thirdly, a complicated software algorithm is required to process the output with respect to the frequency of each pulse. Additionally, a considerably more expensive receiver, more expensive by a factor of approximately 10, would be needed if the weapon detection system of U.S. Pat. No. 6,359,582 were adapted to transmit and receive millimeter-wave radiation, resulting in an unaffordable detection device.

It is an object of the present invention to provide an inexpensive, hand-held and easy to operate millimeter-wave detection device to detect concealed objects.

It is an additional object of the present invention to provide a millimeter-wave detection device and method for detecting concealed weapons without having to generate an image of an irradiated target.

It is an additional object of the present invention to provide a millimeter-wave detection device that is capable of determining at which specific locations of a suspect a concealed object is found.

It is an additional object of the present invention to provide a millimeter-wave detection device that is capable of detecting concealed objects by irradiating a single pulse or few pulses.

Other objects and advantages of the invention will become apparent as the description proceeds.

### SUMMARY OF THE INVENTION

In a first embodiment the invention is a hand-held millimeter-wave detection device for detecting and identifying concealed objects. The detection device comprises:
(a) a non-imaging sensor for generating and transmitting pulses of millimeter electromagnetic waves to the target and receiving pulses that are reflected from the target;
(b) memory means comprising information necessary to determine the properties of the concealed objects from the characteristics of the reflected pulses;
(c) a signal processor for determining the presence and properties of the concealed object by analyzing the received reflected pulses, determining their characteristics, and comparing the determined characteristics with values stored in the memory means;
(d) a software module comprising the algorithms and other dedicated programs used to operate the detection device, to analyze the reflected signals, and to determine the properties of the concealed objects; and
(e) a control device comprising electrical circuitry adapted to enable the operator to select the mode of operation and otherwise manually influence the operation of the detection device.

The properties of the concealed objects that can be determined by the detection device are: the material from which the objects are made, the size of the objects, and the shape of the objects.

In one embodiment of the detection device of the invention, the pulses of millimeter waves are generated at two or more distinct frequencies, thereby improving the uniformity of the reflection from the whole of the target.

The characteristics of the reflected pulses that can be determined by the detection device are: the maximum amplitude of the pulse, the instantaneous rise of the amplitude, and the deviation between the maximum amplitude and the instantaneous rise in the amplitude.

According to different embodiments, the detection device of the invention can be operated in one or more of the following modes: normal mode, integration mode, and high PRF integration mode. In some embodiments front portion in which the antenna is housed is rotatable allowing the orientation of the emitted beam to be varied.

In preferred embodiments of the invention, the non-imaging sensor comprises:
(a) a generator that generates continuous wave millimeter waves;
(b) a power supply that provides electrical power to the components of the detection device;
(c) a modulator that modulates the output of the generator;
(d) one or more antennas for transmitting the modulated output of the generator and receiving millimeter waves reflected from a target;
(e) a detector for detecting the reflected millimeter waves;
(f) a filter for filtering the detected waves;
(g) amplifiers that amplify the signals detected by the detector and the signals that pass through the filter; and
(h) display devices.

The generator of the non-imaging sensor is preferably a Gunn oscillator and the filter is a narrow-band pass filter compatible with the modulation frequency of the modulator. The modulator can be either a mechanical modulator or an electrically switching modulator.

The non-imaging sensor can comprise either two antennas, one of which transmits and one of which receives the millimeter-waves, or one antenna, which alternately transmits and receives millimeter-waves. The npn-imaging sensor can also comprise two sets of antennas operating in a perpendicular polarization mode. In preferred embodiments of the invention the transmitting antenna is configured such that an elliptically shaped beam of millimeter waves is generated. preferably the elliptical beam impinging upon a target has a major axis of approximately 20 cm to 30 cm and a minor axis of approximately 2 cm to 4 cm when the detection device is held at a distance of 3 to 4 meters from the target.

According to another embodiment of the detection device of the invention, the memory, signal processor, and software can be replaced by electrical circuitry designed to transfer the intensity of the reflected pulses directly to a loudspeaker or signal light. Using this embodiment the operator will make a decision concerning the possible presence of a suspicious object that should be further investigated by other means based on the intensity of the sound or light.

In another aspect the invention is a method for detecting concealed objects. The method comprises the steps of.
(a) providing a millimeter-wave detection device according to the invention;
(b) aiming the device at a selected target; and
(c) activating the detection device whereby millimeter waves are generated and propagated towards the target, whereby the signal processor of the detector is adapted to determine the presence and characteristics of the concealed objects from the characteristics of the reflected pulses.

In a preferred embodiment of the method of the invention, the target is searched for the presence of concealed weapons by scanning the propagated millimeter-waves across the target one or more times.

In a preferred embodiment of the method of the invention, the antennas of the detection device are configured such that an elliptically shaped spot of millimeter-waves impinges upon the target. The elliptically shaped spot preferably has a major axis of approximately 20 cm to 30 cm and a minor axis of approximately 2 cm to 4 cm when the detection device is held at a distance of 3 to 4 meters from the target.

In different embodiments of the method of the invention the detection device can be operated in one or more of the following modes: normal mode, integration mode, and high PRF integration mode.

### BRIEF DESCRIPTION OF THE DRAWINGS

In the drawings:

FIG. 1 is a photograph of an exemplary detection device, according to one embodiment of the invention;

FIG. 2 is a block diagram of a non-image sensor housed in the detection device of FIG. 1;

FIG. 3 is a schematic diagram of a mechanical modulator suitable for use in the non-image sensor of FIG. 2;

FIG. 4 is a schematic diagram of an electronically switching modulator suitable for use in the non-image sensor of FIG. 2;

FIG. 5 is a schematic drawing of a needle indicator for displaying the determined material of a concealed target object;

FIG. 6 is a block diagram of the detection device of FIG. 1;

FIG. 7 is a flow chart showing a systematic method of searching a person for concealed weapons or hidden objects;

FIG. 8 schematically illustrates the procedure outlined in FIG. 7; and

FIGS. 9A and 9B schematically illustrate the basis of methods for estimating the size of a detected concealed object.

### DETAILED DESCRIPTION OF PREFERRED EMBODIMENTS

The present invention is an inexpensive, hand-held, and easy to operate millimeter-wave detection device that employs a non-imaging sensor which radiates a pulse of millimeter waves of a certain amplitude and frequency towards a target located at a distance from the detection device. The sensor receives pulses of millimeter waves that are reflected from the target and generates a voltage waveform that is characteristic mainly of the target material, while other parameters such as distance to the target are known and inserted into calibrations. The processor of the detection device measures both the peak voltage and the rate of increase of the voltage until it reaches the maximum. Using an algorithm stored in a software module, the deviation between the rate of the voltage rise and the peak voltage is compared with values of similar parameters for a number of test targets made of different materials that were previously collected and stored in a calibration table in the memory of the device. A concealed object, e.g. a weapon, is positively identified when the measured voltage rise is found to be similar to one of the stored voltage rises. The circuitry of the detection device generates a visual and/or audio output to a display device which is indicative to the operator as to whether a concealed object is present and, if a match is found with the data in the calibration table, the nature of the concealed object is also displayed. In addition to the basic mode of operation described, various other operation modes and corresponding algorithms, two more of which will be described hereinbelow, can be employed with the detection device of the invention.

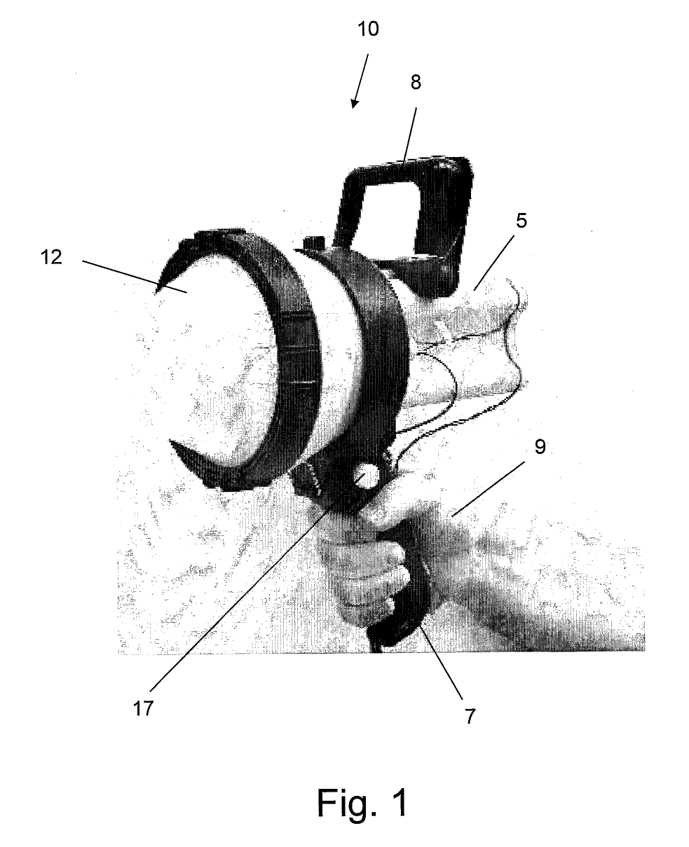

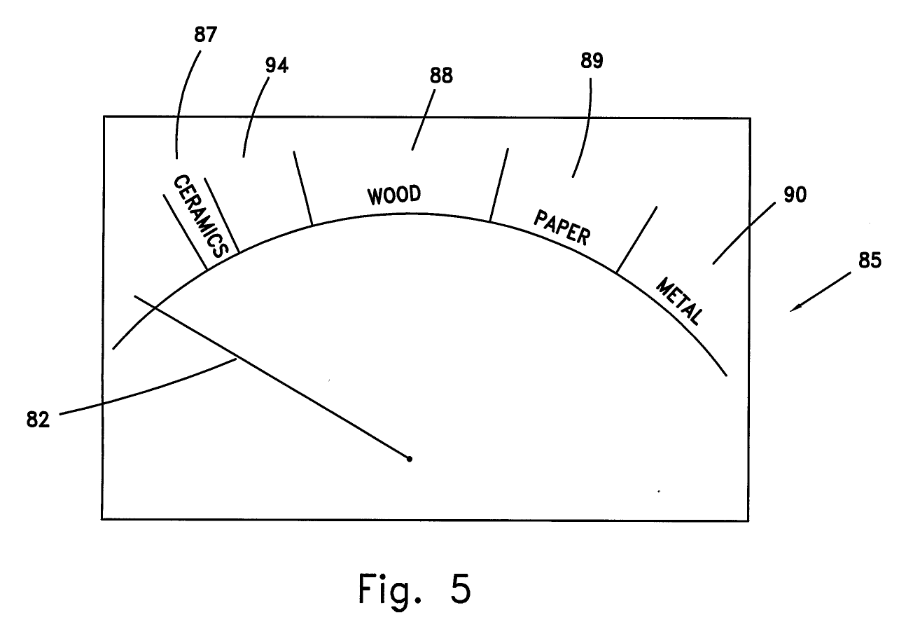

FIG. 1 is a photograph of an exemplary hand-held millimeter-wave detection device generally indicated by numeral 10, according to one embodiment of the invention. Detection device 10 has a casing 5 in which is housed the non-imaging sensor, and a grip 7 extending downwardly from casing 5 by which detection device 10 is held by the operator's hand 9. The transmitting and receiving antennas are housed in enlarged front portion 12 of casing 5, which is made of a material transparent to millimeter-wave energy, e.g. polystyrene foam. Front portion 12 may be rotatable with respect to the horizontal axis, in order to change the orientation of the generated millimeter wave beam. Activation button 17 is located on the side of grip 7 and is accessible to the thumb of the operator. After activation button 17 is depressed, the power supply is energized and millimeter waves are generated. Pivotally mounted display 8 is connected to the top of casing 5 so that the display corresponding to the output of the detection device may be visible to the operator. The display device may be embodied by a needle scale (shown in FIG. 5), by a liquid crystal display (LCD) on which textual information and/or alarms may appear in color, or by a plurality of light-emitting diodes (LEDs). The length of an exemplary detection device is 25 cm, its width and depth are 10 cm excluding the grip and the display mount, and its weight is 1 kg. Many variations in the design of the detection device are possible, for example activation button 17 could be replaced with a trigger, similar to that on a gun or an electric drill that is activated by a finger or fingers.

Detection device 10 is typically held at a distance of 3-4 meters from the suspect, so that the power flux of the generated millimeter waves impinging upon the selected target with an elliptically shaped beam preferably having a height of 20 cm to 30 cm and width of 2 cm to 4 cm will be less than 10 mW/cm², which is not injurious to humans. The power density of the reflected waves is significantly less than that of the transmitted millimeter waves due to the diffusing effect of the target; therefore the danger to the operator is also negligible, even after prolonged use of the detection device of the invention.

Detection device 10 can be provided with a sight (not shown), in order to direct the generated millimeter waves at a selected bodily portion of a suspect, such as the arms or legs. Since the generated millimeter waves have a relatively small wavelength of approximately 3 mm and the detection device has a relatively high spatial resolution, bodily portions of a suspect such as the arms or legs can be accurately identified and searched. The sight may be a laser indicator that is aligned with the transmitting and receiving antennas such that the target which is irradiated by the millimeter waves is also illuminated by a small red laser dot. Alternatively, the sight may be a light source, e.g. a flashlight, provided with an expansion angle similar to that of the transmitting and receiving antennas so that the target which is irradiated by the millimeter waves is also illuminated by a spot of visible light oriented in the same direction and of the same size as the millimeter waves. The sight may also be a conventional sight used in conjunction with firearms which does not illuminate the target but is capable of accurately directing the generated millimeter waves to a selected target. In a fourth configuration, the sight comprises a camera aligned with the transmitting and receiving antennas, whereby the target is displayed on the display device, such as a small LCD, or remotely displayed on a monitor located in a control room.

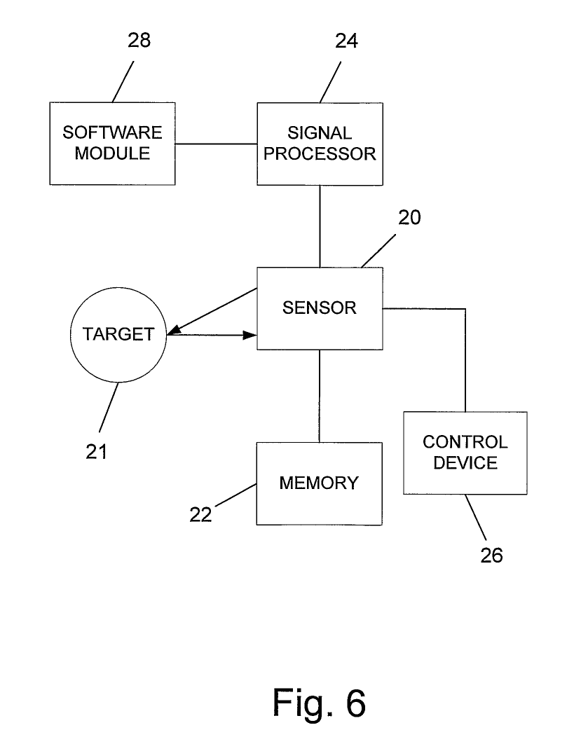

FIG. 6 is a block diagram of detection device 10. Detection device 10 comprises non-imaging sensor 20 for generating and transmitting pulses of millimeter waves to the target and receiving pulses that are reflected from target 21; memory means 22 in which is stored information necessary to analyze the reflected pulses, e.g. a calibration table in which the predetermined voltage rise for known test materials is stored; signal processor 24 for determining the material from which the concealed object is made and for computing the measured voltage rise and comparing it with stored voltage rises; software module 28 containing the algorithms and other dedicated programs used to operate the device, analyze the reflected signals, and determine the characteristics of the concealed objects that are found; and control device 26, in electrical communication with non-imaging sensor 20, which comprises suitable electrical circuitry adapted to enable the operator to select the mode of operation of the device and otherwise manually influence its operation.

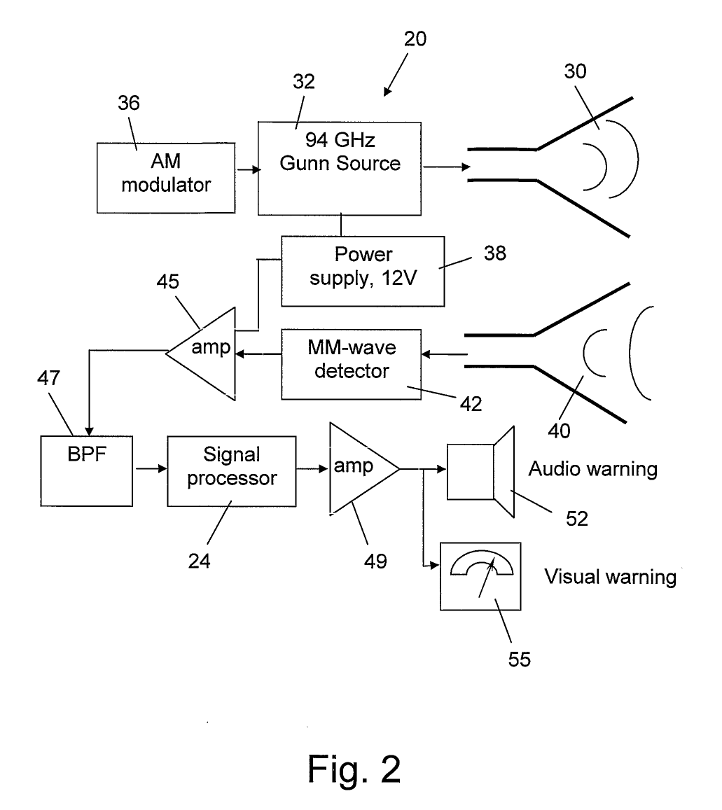

FIG. 2 is a block diagram of the non-imaging sensor, which is generally indicated by numeral 20. Sensor 20 comprises W-band transmitting antenna 30 and receiving antenna 40, which preferably have a shape and dimensions such that the size of a spot on the target will be of the desired shape and sufficiently large to reduce the time of a detection operation. The beam size of the generated millimeter waves is inversely proportional to the antenna size: therefore, for a fixed distance from the target, increasing the size of transmitting antenna 30 will reduce the beam width and spot size, thereby increasing the detection resolution and the gain. On the other hand, a smaller sized spot will necessitate a detection device of larger overall dimensions due to the larger size of the antenna. Inherently there is a conflict between two needs: a small spot size gives a good detection resolution, but requires a long time to scan a suspect. With a large spot a fast scan is possible but the resolution of detection is poor. The inventors have has discovered that a practical, good compromise between these two needs, i.e. providing good detection resolution and a practical scan time, is an elliptical spot having a major axis of approximately 30 cm and a minor axis of approximately 2-3 cm. With this arrangement, five horizontal scans will cover an adult (from the chest to the legs. these five scans can be done rather quickly and indicate with satisfactory resolution the location of the concealed object. It will be appreciated that other antenna types and sizes may be employed as well. By rotating front portion 12 (FIG. 1) of the detection device, the orientation of the millimeter wave spot impinging upon the target may be changed, and therefore various bodily portions may be more accurately scanned. Using the spot size mentioned above, two vertical scans will be needed to cover a suspect. If so desired, a single transceiver can be used for both transmitting and receiving when a suitable coupling or switching element, such as a circulator, is employed. Likewise, another pair of antennas of opposite polarization may be employed to further reduce target fluctuations.

After the power supply 38, e.g. of 12V, is suitably activated, sinusoidal millimeter waves are generated by a continuous wave (CW) Gunn diode oscillator 32 operating at a single frequency ranging from 90-100 GHz, e.g. 94 GHz, and electrically connected to power supply 38. At this bandwidth, when a signal having strength of approximately 10 mW is generated, the size and resolution of the detection device are optimized. Furthermore the cost of the detection device made using these components can be kept relatively low due to the availability of the standard components from which it is produced. Other millimeter wave generators such as the IMPATT diode may be employed, although the CW Gunn diode oscillator is the most cost effective generator. It is to be noted that although in FIG. 2 power supply 38 is shown connected only to the millimeter-wave generator and amplifier 45, it actually supplies power to all components of the detection device that require electricity.

The frequency of the generated millimeter waves are modulated by modulator 36 so that the reflected waves may be more easily identified, and to improve the signal to noise ratio (SNR). The modulation frequency is preferably an easily generated value of approximately 1 KHz, which is in the audible range. The modulated millimeter waves are propagated to transmitting antenna 30. Following radiation of the modulated millimeter waves from transmitting antenna 30 to a target (not shown), the waves are reflected by the target and are received by receiving antenna 40. Receiving antenna 40 transmits the signal from the reflected waves to detector 42, which is preferably a zero-biased Shottky detector, for providing an optimal sensitivity level. The reflected waves received by detector 42 are amplified by amplifier 45 being powered by power supply 38 and are filtered by narrow-band pass filter (BPF) 47. BPF 47, which is compatible with the modulation frequency of modulator 36, is a square wave filter for filtering one basic harmonic.

The filtered signal is transferred to the signal processor 24 where information relating to the presence and properties of a concealed object is determined. The measured instantaneous deviation of the voltage rise from the peak voltage is indicative of the material of which a concealed object being detected is comprised. The detection device is calibrated prior to a detection operation and the results for different materials stored in the form of a calibration table in memory 22. The signal processor compares the currently measured deviations with those in the calibration table and, when the deviation is substantially equal to the one of the stored deviations for a known test material, a given output will be generated, amplified by amplifier 49, and transferred to an appropriate display means. When the selected modulation frequency is in the audible range, the amplified filtered signal may be output directly to a speaker 52, whereby the volume of the audible signal is indicative of the presence of a concealed object and possibly of the material of which it is comprised. The amplified signal from processor 24 may also be output to visual indicator 55, or any other suitable display device, which is driven by amplifier 49.

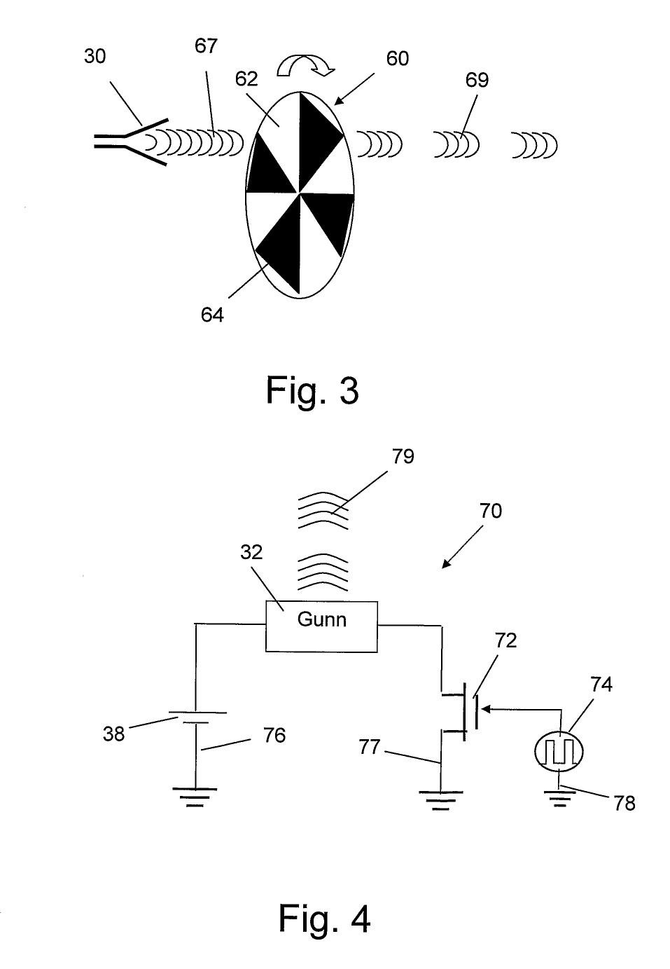

While prior art millimeter wave modulators are made from expensive solid state GaAs-based semiconductor devices because of the necessity of being able to measure and make use of the information contained in the changes in the intensity or frequency of the modulated signals. In the present invention there is no use made of the information contained in the modulated signals and the purpose of the modulation is merely to distinguish the waves reflected from the target from background radiation. To accomplish this, a simple on-off modulation is all that is required. Therefore the cost of the detection device of the invention can be significantly reduced by employing a mechanical modulator shown in FIG. 3 or an electronically switching modulator shown in FIG. 4.

As shown in FIG. 3, the mechanical modulator is embodied by a chopper 60 positioned on the target side of transmitting antenna 30. Chopper 60 is a rotating disc from which selected sectors 62, e.g. 4 sectors, having a diameter substantially equal to, or slightly greater than, the aperture width of transmitting antenna 30, e.g. approximately 3 cm, are removed. As chopper 60 rotates about its center, millimeter waves 67 radiating thereto from transmitting antenna 30 with a characteristic directivity alternately propagate through a removed sector 62 and are blocked by a solid sector 64. A periodically modulating wave front 69 is thereby generated, which impinges upon, and is reflected from the target. In this embodiment, chopper 60 is disposed at the output side of oscillator 32 (FIG. 2).

As shown in FIG. 4, electronically switching modulator 70 comprises switching element 72, e.g. a MOSFET switching transistor; control element 74, e.g. a local oscillator or a clock; Gunn oscillator 32, which is connected to DC power supply 38 and to switching element 72. Power supply 38, switching element 72, and control element 74 are grounded by wires 76, 77, and 78, respectively, e.g. to a common ground such as the detection device casing. Control element 74 generates a square wave that alternately opens and closes switch 72. As switch 72 is opened, Gunn oscillator 32 ceases to generate millimeter waves, and therefore periodically modulated millimeter wave front 79 is generated. Electronically switching modulator 70 may advantageously control the sequence and/or frequency of modulation. Consequently, a low-duty cycle may be generated by modulator 70, by which the peak radiated power may be increased so as to increase the SNR of the Shottky detector while the average power remain constant so as to generate millimeter-wave radiation at a safe level. For example, the duty cycle has a period of 1 ms, a pulse width of 100 μs, a peak voltage of 5 V, and a rise time of 1 μs. In this embodiment, electronically switching modulator 70 is disposed at the power supply side of oscillator 32 (FIG. 2).

Accurate and cost effective detection of concealed weapons and hidden objects are made possible by properly calibrating the Shottky detector. The detection device is set to a calibration mode by depressing a suitable button. Millimeter waves are then generated and directed towards a selected target made of a known material at a desired known distance. The voltage rise corresponding to the waves reflected by a selected target test material and transmitted by the Shottky detector, which corresponds to the reflection of millimeter waves by the selected target material, is then stored within the memory of the detection device processor. This process is repeated for other selected target test materials. The detection device may be factory calibrated for standard materials, or may be calibrated by an operator at a detection site, in anticipation of weapons or contraband that may be concealed at the given site. After the average voltage rise for all selected target test materials is stored, the detection device is set to a detection mode by depressing a suitable button. When the detection mode is set, an operator may commence a detection operation by directing the transmitting antenna at a target object and depressing a trigger, whereupon pulses of millimeter waves are generated and fired at the target until the trigger is released so that the measured voltage rise of the reflected pulses may be compared with the stored voltage rises. Alternatively, a detection operation is initiated by pressing activation button 17, whereupon a single pulse of millimeter waves is generated and fired at the target, after which control device 26 (FIG. 6) terminates operation of millimeter generator 32 (FIG. 2). If the measured voltage rise is substantially equal to the stored voltage rise of a known test material, the operator receives a distinct and unequivocal indication that the target object is a concealed weapon or a specified hidden object. Since the voltage increase rate associated with metal objects is substantially greater than that of other materials, metallic objects are easily distinguishable from other types of concealed objects. If a metallic object is detected, the operator then is required to visually or bodily inspect the suspect, to determine whether the detected object is indeed a weapon. When the operator quickly receives an output indicating that the detected target object is not a concealed weapon, the trigger is released, if a trigger is employed, and the detection device ceases to operate. Another detection operation is then subsequently performed.

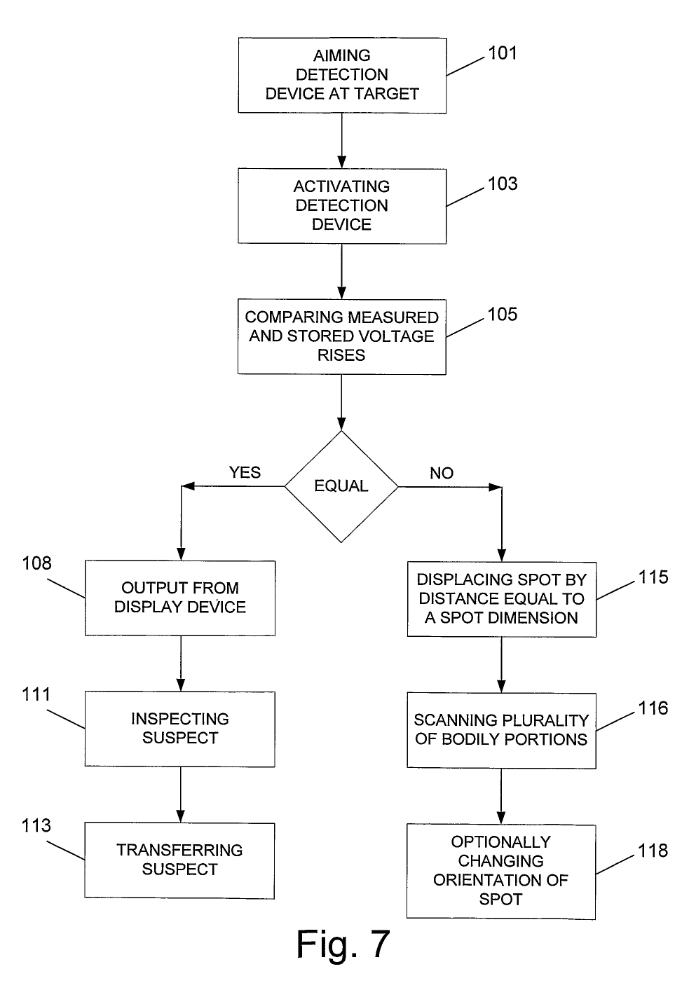

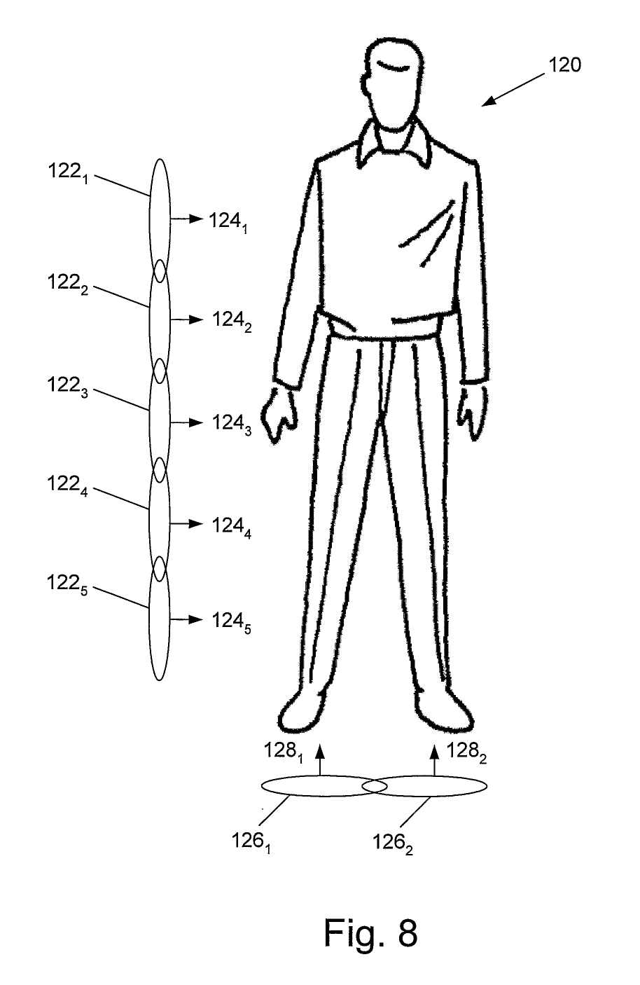

There are a variety of different ways to carry out a search for concealed weapons using the system of the detection device of the invention. For example, the operator can carry out spot checks by aiming the beam at only the waist of the person being inspected. FIG. 7 is a flow chart that shows a more systematic method of searching a person for concealed weapons or hidden objects. FIG. 8 schematically illustrates one embodiment of the procedure outlined in FIG. 7. The procedure illustrated is carried out using the preferred embodiment of the detection device that produces an elliptical beam. When an operator notices a person 120 approaching the checkpoint, he aims [step 101] the detection device slightly to the side of the person. The operator then activates the detection device [step 103] so that millimeter waves will be generated and propagated in the selected direction. The ellipse 122₁ is oriented with its major axis in the vertical direction and the beam is swept across the body of person 120 in the direction indicated by arrow 124₁. The voltage rise of the signal from the millimeter waves reflected from the target are processed and compared with the data stored in the calibration table [step 105]. If no signal change that is characteristic of the presence of a hidden object or no voltage rise that is substantially equal to any of the stored voltage rises which indicates that a concealed weapon or any other potentially dangerous hidden object is present has been detected, then the operator lowers the detection device to position 122₂ [step 115] and performs another scan, after which step 105 is executed again. By carrying out additional scans 122₃, 122₄, and 122₅, (returning to step 105 at the end of each scan and proceeding to step 108 whenever a concealed object is detected.) the entire body can be scanned [step 116]. If necessary, the operator may change the orientation of the elliptical spot by rotating the front portion of the detection device, until the major axis of the ellipse is horizontal and then carry out scans 126₁ and 126₂ [step 118] by scanning the beam in the vertical direction shown by arrows 128₁ and 128₂. Many variations of the above described procedure are of course possible. For example, referring to FIG. 8, the process can be made more efficient and faster by performing scans 122₁, 122₃, and 122₅ from left to right and scans 122₂ and 122₄, from right to left. An alternative sequence of scans is to scan the stomach and chest of the suspect with the major axis of the ellipse vertically disposed, and to scan the arms and legs with the major axis having the same orientation as the long dimension of the limb, in order to be able to pinpoint the location of a concealed object and shorten the time required to carry out the inspection.

If the measured voltage rise of reflected waves from one bodily portion is substantially equal to a stored voltage rise [step 105], an output is generated from the display device [step 108] that indicates to the operator that a concealed weapon or other hidden object has been detected. Depending on the nature of the information on the display device the operator then visually inspects the suspect [step 111] in order to verify the nature of the detected object. For safety reasons, if the indications are that a weapon or explosives has been detected, then the inspection is carried out from a distance, for example by asking the suspect to remove his coat: if the indications are that the object is not potentially dangerous, the operator can approach the suspect. Finally, if a weapon or any other potentially dangerous object has been found on his body or if there is a high probability that this is the case, the suspect is then transferred to a law enforcement professional [step 113].

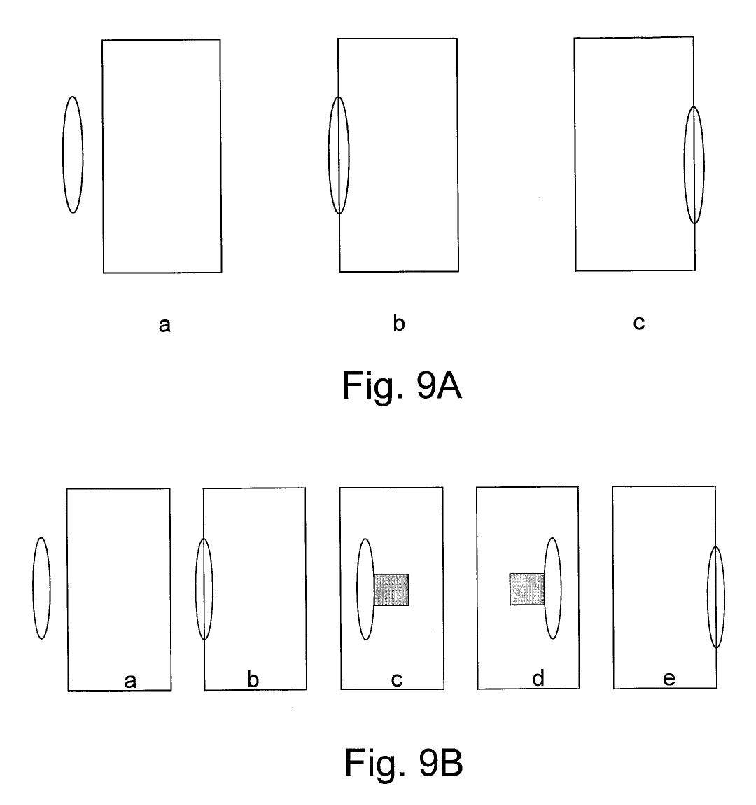

Information concerning the size and shape of the concealed object can be obtained by proper use of the detection device of the invention and correct processing and interpretation of the signals reflected from the target. FIGS. 9A and 9B schematically illustrate the basis of methods for estimating the size of a detected concealed object. In FIG. 9A there is no concealed object in the container that is being scanned. The scan is carried out from left to right and at each of the interfaces, shown in b and c, the intensity of the reflected signal will “jump” as the beam crosses from one medium to another. In the scan depicted in FIG. 9B, a concealed object is present in the interior of the container. In this case there will be measured four discontinuities in the return signals corresponding to the boundary between the air and the container (b), the material of the container to the material of the concealed object (c), the material of the object to that of the container (d), and the container to air (e). The signal processor of the detection device can record the time (either absolute or relative) at which each of these events occurs. Making the very reasonable assumption that the scanning speed is uniform, the ratio of the time it takes for the beam to cross the concealed object to the time it takes for the beam to cross the container is equal to the ratio of their widths. Therefore, if the width of the container is known or can be estimated, than the width of the object can be determined. As an example, the width of an average adult can be taken as 50 to 60 cm. A more accurate determination can be made in situations such as airports, banks, etc. where at some point all of the passengers/customers are required to pass in a single file along a well-defined passageway. In such a case, on either side of the passageway, e.g. on the poles that hold up the ropes that define the way, a corner reflector designed for maximum reflection of millimeter waves is attached pointing back towards the location of the operator of the detection device. When a person passes between the two corner reflectors scans are carried out as described above. Each scan begins with a corner reflector on one side of the person and ends at the corner reflector on the other side. The distance between the two reflectors is known exactly and the very strong return signal from the corner reflectors gives an unequivocal measure of the time of the scan, which then can be easily be converted to the exact dimension of any concealed object that is detected. The calculation can be performed manually by the operator or preferably automatically by the signal processor and displayed on the display of the device.

Information about the shape of the concealed object can be obtained by analyzing the return signals. For example, if the target object is flat, such as a cardboard sheet, the reflected signals are stable. However, if the reflected signals reflect a phase shift or are otherwise not stable, this is an indication that the concealed object is curvilinear, such as a cylinder. Various algorithms for analyzing the signals and criterion for decision-making are defined in the software module associated with the processor in order to provide information about the shape of the object.

FIG. 5 illustrates an exemplary visual display, which shows the output of the detection device following a detection operation. The illustrated visual display is a needle display 85 provided with a plurality of output regions 87-90, each of which corresponds to the output signal for a different type of concealed object, such as one made of metal, paper, wood, or ceramics, that has been irradiated by millimeter waves. In response to a detection operation whereby the signal processor transmits the voltage rise corresponding to the target object to needle display 85, needle 92 is displaced an angular distance proportional to the output signal until it is positioned in one of the output regions 87-90. The operator views the display and determines whether the target object is potentially a concealed weapon, and if so, e.g. if needle 92 is positioned in ceramic region 87 or metal region 90, visually inspects the suspect. The operator may adjust the sensitivity of needle detector 95, e.g. after viewing an output that the target object is made of ceramics, to determine whether the output voltage of the detected ceramic object is characteristic of a concealed weapon. Needle detector 85 is also provided with region 94, which is indicative that the material of the target is unknown. Needle detector 85 may be supplemented by an audible alarm which is activated, e.g. when needle 82 moves into the metal region 90.

In another embodiment, the millimeter waves may be generated at two or more distinct frequencies, so that the concealed objects may be better distinguished as a result of a different reaction to a frequency and phase shift. The detection device of the invention can not analyze differences in phase; nonetheless by using different frequencies difficulties in identifying a concealed object caused by specular reflection, i.e. maximum reflection from specific points and no reflection from neighboring points on the target, be reduced. The location of the maximum and minimum points depends on several factors including the phase with which the wave strikes the target at the specific location. For even very small changes in the frequency the phase from the source to the target will change. Thus, for frequencies that are even slightly different, the waves that strike the same point on the target will have a different phase for each frequency. The result of this is that for an area from which the reflection is a minimum at one frequency there will be another frequency at which there will be reflection. In this way the reflection will be more uniform from the whole of the target The concealed objects may also be distinguished by means of a set of antennas operated in a perpendicular polarization mode.

As stated hereinabove, the detection device of the invention can be operated in three different operating modes:
In the normal mode, which has been described hereinabove, the software relates to the momentary measurements and the processing is done on a single pulse.
The integration mode is based on the fact that in a typical scan using pulses generated at a frequency of e.g. 1 kHz, a number of pulses reflected from essentially the same area of the target will be received by the detection device. For example, if the length of the scan is 0.7 meters, the time of the scan 0.5 seconds, i.e. scanning speed 1.4 meter/second, and the time between pulses is 0.001 seconds, then the distance the beam moves between pulses is 0.0014 meter. In other words the transmitted beam moves between 1 mm to 2 mm between pulses and a target having a width of five centimeters will return at least 25-50 pulses, wherein the horizontal movement between the reflected pulses is also between 1 mm and 2 mm.
Because of small differences in phase resulting from the differences in distance between the transmitted and received pulses there is to be expected a variation in intensity of sequential reflected pulses. The measured intensity of the reflected pulses will vary between a maximum value and zero. This result is apt to interfere with a clear identification of the target. In order to overcome this problem an integration process is carried out between neighboring pulses. As a result of the integration the envelope that alternated between a maximum and a minimum is smoothed out providing a clearer indication of the nature of the target.
The purpose of the high Pulse Repetition Frequency (PRF) integration mode is to improve the SNR and to allow detection of weaker targets, i.e. smaller or more distant targets. Alternatively, working in this mode can reduce the requirements on the detection element and thereby to reduce its cost.
In this mode, the pulse rate is higher than the other modes, e.g. 10 kHz or greater. As a result of the higher frequency, the lateral motion between pulses of the beam on the target is very small and the situation can be achieved in which the motion between 10 adjacent pulses is essentially zero and the reflected pulses obtained from the ten pulses will be essentially the same. If we now assume a very weak target, then integration of the results from the ten pulses will improve the SNR by a factor equivalent to the square root of the number of pulses.

Not all embodiments of the detection device of the invention use all three modes of operation described herein. Various combinations will be chosen depending on the nature of the hidden objects the device is expected to encounter. The modes can be selected manually or the device can be programmed to shift automatically between modes in order to provide more information to give more accurate results.

A very simplified embodiment of the detection device of the invention is also anticipated by the inventor. This invention will only give a “yes” or “no” alarm, audible and/or visual, if a concealed object made of metal is detected. This is possible because the pulses reflected from a metallic object have a signal strength that is much higher than those reflected by non-metallic objects. In this case the memory need only contain the threshold value of the signal and the requirements for the signal processor and software are also minimal. The memory, signal processor, and software can also be eliminated entirely and the circuitry designed to transfer the intensity of the reflected pulses directly to a loudspeaker or signal light. The operator will then make a decision concerning the possible presence of a suspicious object that should be further investigated by other means based on the intensity of the sound or light.

### Example

In order to check the feasibility of using the detection device of the invention to distinguish between different types of materials the maximum voltage of the reflected signal from various target objects made of different metallic and non-metallic materials and having different shapes were tested. The measurements were made using standard conditions, i.e. distance, strength of transmitted signals, frequency, etc.

A 20-L plastic container filled with tap water served as a simulation of a human body. Since a combination of the human body and a plastic carton, in which a potentially dangerous object is concealed, is commonly found during detection operations, such a combination was simulated by placing test objects having a height of 25 cm containing different types of concealed material such as plastic, cardboard, Teflon, ceramic, cheese, and soap, in front of the plastic container. A Shottky detector was positioned at a distance of 1 m from a test object irradiated by millimeter waves having a frequency of 94 GHz, which were generated by a Gunn oscillator. The background noise from the laboratory walls did not exceed 5 mV. The Shottky detector was sufficiently sensitive to detect the presence of all of the test objects. Table I specifies the maximum voltage measured for each of the test objects.

As can be seen in Table I, the amplitude of the reflected signal received from each test object has a unique value. For example, the voltage for Test Object 12 containing a soap pack was 95 mV, while the voltage for Test Object 13, which is identical to Test Object 12 but not containing the soap pack, was 50 mV. An operator during a detection operation will therefore be able to instantly determine whether a target object is metallic. However, comparing a measured voltage increase to a stored voltage increase does not also indicate the presence of a concealed potentially dangerous object. For example, the output voltage of Test Object 13 made of soap was 50 mV and of Test Object 15 made of metal was 55 mV. Such a small difference may be prone to error, and therefore an operator may not accurately determine whether the target object is metallic. Therefore reliance on another parameter, i.e. the voltage increase rate, is needed by an operator to accurate determine the presence of a potentially dangerous concealed object.

TABLE I
Voltage Increase of Test Objects

| | | | | Voltage |
|---|---|---|---|---|
| | | | | Increase, |
| Number | Test Object | Size | Material | mV |
| 1 | Cylindrical | D = 30 cm | Filled with Tap Water | 25 |
| | Plastic | H = 40 cm | | |
| | Container | | | |
| 2 | Empty Tee Cap | D = 7.5 cm | Ceramic | 45 |
| | | H = 9 cm | | |
| 3 | Cylinder | D = 6.5 cm | Teflon | 90 |
| | | H = 30 cm | | |
| 4 | Sheet | 17 × 10 × 1 cm³ | Cardboard | 90 |
| 5 | Empty | 26 × 17 × 5 cm³ | Laminate Cardboard | 250 |
| | Rectangular | | | |
| | Box | | | |
| 6 | Empty | 14 × 10 × 5 cm³ | Cardboard | 75 |
| | Rectangular | | | |
| | Box | | | |
| 7 | Rectangular | 14 × 10 × 5 cm³ | Cardboard | 360 |
| | Box Filled with | | | |
| | Plastic | | | |
| | Granules | | | |
| 8 | Empty | 10 × 10 × 5 cm³ | Plastic | 70 |
| | Rectangular | | | |
| | Box | | | |
| 9 | Rectangular | 24 × 12 × 4 cm³ | Foam | 80 |
| | Bar | | | |
| 10 | Rectangular | 26 × 4 × 2 cm³ | Wood | 60 |
| | Rod | | | |
| 11 | Rectangular | 16 × 8 × 2 cm³ | Cheese (“Emed” Brand) | 90 |
| | Box | | | |
| 12 | Rectangular | 10 × 5 × 3 cm³ | Soap (“Dead Sea” | 95 |
| | Box containing | | Brand) | |
| | a Soap Pack | | | |
| 13 | Test Object 12 | 9.5 × 5 × 2.5 × 2 cm³ | Soap (“Dead Sea” | 50 |
| | without Pack | | Brand) | |
| 14 | Metal Plate - inside | 10 × 10 × 5 cm³ | Aluminum, | 240 |
| | Cardboard Box | (Box) | 5 × 5 cm² | |
| 15 | Metal Ball - inside | 10 × 10 × 5 cm³ | Steel, | 55 |
| | Cardboard Box | (Box) | 2-cm diameter | |
| 16 | Background | | Laboratory Walls and | 5 |
| | Noise | | Equipment | |
| 17 | Metal Plate | D = 10 cm | Aluminum | 750 |
| | | H = 10 cm | | |

While some embodiments of the invention have been described by way of illustration, it will be apparent that the invention can be carried into practice with many modifications, variations and adaptations, and with the use of numerous equivalents or alternative solutions that are within the scope of persons skilled in the art without exceeding the scope of the claims.

1-22. (canceled)

23. A hand-held millimeter-wave detection device for detecting and identifying concealed objects, comprising:
(a) a non-imaging sensor for generating and transmitting pulses of millimeter electromagnetic waves to the target and receiving pulses that are reflected from said target;
(b) memory means comprising information necessary to determine the properties of said concealed objects from the characteristics of the reflected pulses;
(c) a signal processor for determining the presence and properties of said concealed object by analyzing the received reflected pulses, determining their characteristics, and comparing said determined characteristics with values stored in said memory means;
(d) a software module comprising the algorithms and other dedicated programs used to operate said detection device, to analyze the reflected signals, and to determine the properties of said concealed objects; and
(e) a control device comprising electrical circuitry adapted to enable the operator to select the mode of operation and otherwise manually influence the operation of said detection device;
characterized in that said pulses of millimeter waves are generated at two or more distinct frequencies, thereby improving the uniformity of the reflection from the whole of the target.

24. The detection device according to claim 23, wherein the properties of the concealed objects that can be determined are one or more of:
(a) the material from which said objects are made;
(b) the size of said objects; and
(c) the shape of said objects.

25. The detection device according to claim 23, wherein the characteristics of the reflected pulses are one or more of the following:
(a) the maximum amplitude of the pulse;
(b) the instantaneous rise of said amplitude; and
(c) the deviation between said maximum amplitude and said instantaneous rise in said amplitude.

26. The detection device according to claim 23, wherein said device can be operated in one or more of the following modes:
(a) normal mode;
(b) integration mode; and
(c) high PRF integration mode.

27. A detection device according to claim 23, wherein the memory, signal processor, and software are replaced by electrical circuitry designed to transfer the intensity of the reflected pulses directly to a loudspeaker or signal light; whereupon the operator will make a decision concerning the possible presence of a suspicious object that should be further investigated by other means based on the intensity of the sound or light.

28. A method for detecting concealed objects, comprising the steps of:
(a) providing a millimeter-wave detection device according to claim 23;
(b) aiming said device at a selected target; and
(c) activating said detection device whereby millimeter waves are generated and propagated towards said target, whereby the signal processor of said detector is adapted to determine the presence and characteristics of said concealed objects from the characteristics of the reflected pulses.

29. The method according to claim 28, wherein a target is searched for the presence of concealed weapons by scanning the propagated millimeter-waves across said target one or more times.
